(19) United States
(12) Patent Application Publication
(10) Pub. No.: US 2015/0193825 A1
(43) Pub. Date: Jul. 9, 2015

(54) SYSTEM AND METHOD FOR SELECTIVELY PRINTING ADVERTISEMENTS

(71) Applicants: Rho Kook Song, Chicago, IL (US); Hye Sung Kim, Chicago, IL (US)

(72) Inventors: Rho Kook Song, Chicago, IL (US); Hye Sung Kim, Chicago, IL (US)

(73) Assignee: Freenters, LLC, Chicago, IL (US)

(21) Appl. No.: 14/664,398

(22) Filed: Mar. 20, 2015

Related U.S. Application Data
(63) Continuation-in-part of application No. 13/781,332, filed on Feb. 28, 2013.
(60) Provisional application No. 61/604,434, filed on Feb. 28, 2012.

(51) Int. Cl. G06Q 30/02; G06F 3/12

(52) U.S. Cl. CPC G06Q 30/0257; G06Q 30/0269; G06Q 30/0233; G06Q 30/0276; G06F 3/1291; G06F 3/1226; G06F 3/1285

(57) ABSTRACT

The present disclosure provides a computer-implemented system and method for utilizing open space of a document to be printed for selective, targeted advertising based on information (such as demographics) about the user submitting the document. A server connects registered users to a network of dedicated printers that provide free or discounted printing in exchange for the placement of targeted advertising. Targeted advertisements are generated by system operators or submitted by advertisers and stored on the server along with specific placement instructions. The server then distributes the advertisements according to the instructions by merging them into the documents to be printed. Advertiser and user accounts are updated to reflect the transaction and enable various controls and techniques for selecting future advertisements and interacting with placed advertisements. In certain embodiments, the system enables the user to instruct the system to print the user's document advertisement-free if one or more prerequisites are met.

### PRIORITY CLAIM

This application is a continuation-in-part of, and claims priority to and the benefit of, U.S. patent application Ser. No. 13/781,332, filed on Feb. 28, 2013, which claims priority to and the benefit of U.S. Provisional Patent Application Ser. No. 61/604,434, filed on Feb. 28, 2012, now expired, the entire contents of each of which are incorporated herein by reference.

### TECHNICAL FIELD

This invention relates generally to systems and methods for advertising goods and services, and more specifically, to systems and methods for selectively distributing advertisements in print form.

### BACKGROUND OF THE INVENTION

As technology continues to evolve, traditional advertising mediums such as television and radio are no longer as likely to reach certain demographics. Companies and their marketing teams continue to look for new and innovative ways to reach consumers and compete for their attention in a media-filled, fast-pace world. Traditionally, advertisements are positioned along with media that people are drawn to or interested in. But where the advertisements are separate from the desired content, they are now easier to exclude. For example, the development of DVR television recording allows one to simply skip over broadcast commercial content. This is harder to do when the advertisements are interspersed with the media, such as on the display of an internet website or in traditional print media such as a magazine or newspaper.

Despite the growing shift from print to electronic media, there often remains an interest in having a printed copy. For example, a printed copy of a draft document can easily be marked up, highlighted or otherwise amended to suit the needs of the reader or reviewer. It also may be easier on the eyes to read a printed document. Paper copies of documents, thus, remain a reality throughout the business world, in our schools and in everyday life. The average university student, for example, will print more than a hundred pages of documents over the course of a month. This costs the student in paper, ink, and/or copying fees. When the documents are printed, they typically do not utilize the space along the top, bottom and sides. These “margins” are left empty. This margin space represents unutilized advertising real estate ideal for reaching a targeted audience interested in printing particular types of documents.

### SUMMARY OF THE INVENTION

The present invention comprises a selective printing system directed at utilizing the margins or other unused space of electronic documents as a medium for targeted advertisements. In one embodiment, the computer-based system involves a networked server accessible by registered users and advertisers, and linked to one or more dedicated printers. A registered user is someone who has accessed the system and provided certain background or demographic information to an account (i.e., account information). An advertiser is a company or other entity that has submitted advertising media to the server, along with instructions relating to its target audience. In a particular embodiment, when the system server receives an electronic document uploaded from a registered user, it selects advertising according to the instructions such that it is properly targeted based on the user's account information, merges the electronic document to be printed with the advertisement by placing it in one or more of the margins, and causes the merged document to be printed at a network printer for pickup by the user. In this quid pro quo arrangement, the user gets a free hardcopy of the document they submitted and the advertiser reaches its target audience with media that is well-placed. Once the print is complete, accounts of the user and the advertiser are updated to show that a particular ad has been placed with a particular user, thus enabling other functionality as described herein. Several other features, such as system controls and safeguards, payment methods and system status updates, are discussed more fully below

In other embodiments, the system enables the user to instruct the system to print the user's document advertisement-free if one or more prerequisites are met or one or more conditions are satisfied. Put differently, in these embodiments, if the user meets the one or more prerequisites or satisfies the one or more conditions, the selective printing system enables the user to choose to cause the system to print the user's document without merging the user's document with any advertisements. In certain such embodiments, the selective printing system enables a registered user to accumulate points by completing designated tasks offered by the system and to later redeem those accumulated points for advertisement-free printing.

The invention provides a new and useful method for advertising by displaying advertisements in a manner that provides a motivation for use by the advertising target. It also provides a very targeted way to distribute the advertisements to a specific demographic in a selective manner. While one embodiment is referenced above, other embodiments, systems, methods, features, and advantages of the present invention will be, or will become, apparent to one having ordinary skill in the art upon examination of the following figures and detailed description. It is intended that all such additional systems, methods, features, and advantages included within this description, be within the scope of the present invention, and be protected by the accompanying claims.

### BRIEF DESCRIPTION OF THE DRAWINGS

The present invention can be better understood with reference to the following figures.

FIG. 1 is a graphical representation of components of the selective printing system according to certain embodiments.

FIG. 2 is a block diagram of the interfaces in the selective printing system of FIG. 1.

FIG. 3 is a block diagram of one form of a computer or server of FIG. 1 and/or FIG. 2, having a memory element with a computer readable medium for implementing the selective printing system.

FIG. 4 is a flowchart showing steps involved in the set up of a registered user account on the selective printing system according to an exemplary embodiment.

FIG. 5 is a flowchart showing steps involved in the receipt and queuing of advertisements according to an exemplary embodiment.

FIG. 6 is a flowchart showing steps involved in the merging and printing of a merged document according to an exemplary embodiment.

FIG. 7 shows an example of a printed, merged document according to an exemplary embodiment.

FIG. 8 shows an example screenshot of the user application interface including a map including an indication of the user's location and a plurality of indications of the locations of a plurality of dedicated printers within a designated distance of the user's location.

FIG. 9 illustrates an example screenshot 900 of the user application interface of FIG. 8 after the system has received a selection of one of the indications.

### DETAILED DESCRIPTION

The description that follows describes, illustrates and exemplifies one or more particular embodiments of the present invention in accordance with its principles. This description is not provided to limit the invention to the embodiments described herein, but rather to explain and teach the principles of the invention in such a way as to enable one of ordinary skill in the art to understand these principles and, with that understanding, be able to apply them to practice not only the embodiments described herein, but also other embodiments that may come to mind in accordance with these principles. The scope of the present invention is intended to cover all such embodiments that may fall within the scope of the appended claims, either literally or under the doctrine of equivalents.

It should be noted that in the description and drawings, like or substantially similar elements or steps may be labeled with the same reference numerals. However, sometimes these elements or steps may be labeled with differing numbers, such as, for example, in cases where such labeling facilitates a more clear description. Such labeling and drawing practices do not necessarily implicate an underlying substantive purpose. As stated above, the present specification is intended to be taken as a whole and interpreted in accordance with the principles of the present invention as taught herein and understood to one of ordinary skill in the art.

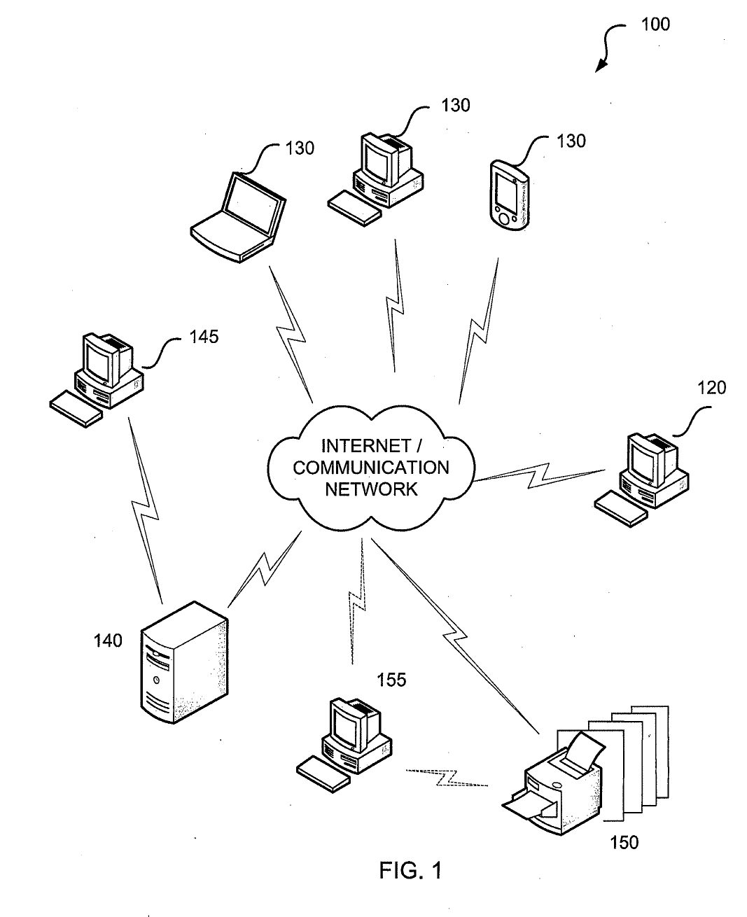

FIG. 1 is a graphical representation of a computer-based or implemented selective printing system 100. The system includes a plurality of registered user computers 130 (or just “user computers”), which can be any variety of electronic devices, such as those shown, that are capable of connection to and communication with a network, such as the Internet or other computer network, in a manner which is known in the art and which will be further understood from the below description. These user computers 130 each can run an interface program, such as an Internet browser application for connecting to the Internet/network, that is capable of communicating with the selective printing system 100, which can be server-based. Specifically, for communicating with user computers 130, an selective printing system server 140 (or just a “system server”) is connected to and in communication with a network, such as the Internet, in a manner which is known in the art. Firewall and other security systems and applications (not shown) may be used to prevent and deter unauthorized access to system server 140, as is known in the computer networking art.

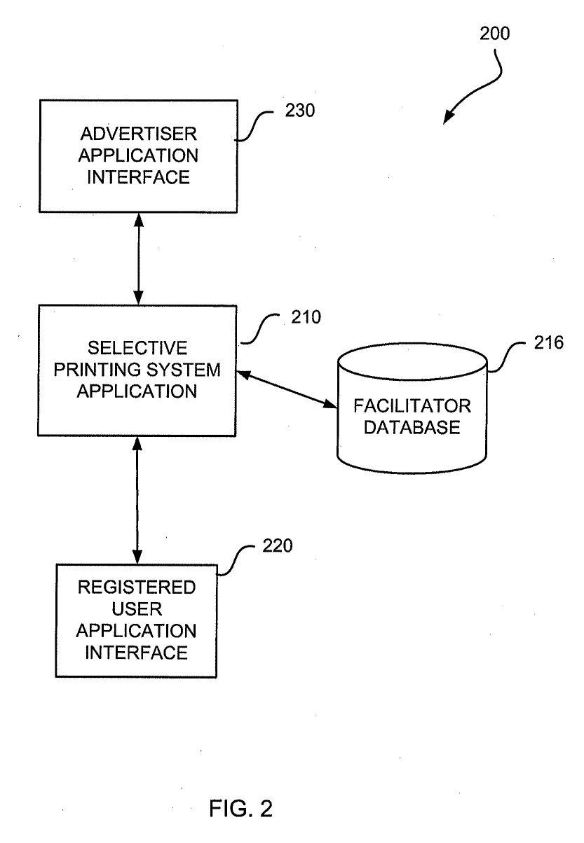

In a similar manner, advertiser computer 120 and dedicated printers 150 are separately connected to and in communication with the network, such as the Internet. Though shown as directly connected, advertiser computer 120 may be connected to the network via an advertiser computer network. Advertiser computer 120 is equipped with advertiser application interface 230 allowing it to interact with the selective printing system application 210 through the network (see FIG. 2). Dedicated printers 150 may be hardwired to system server 140, but are considered to be network printers in the embodiment shown. Ideally, there are numerous dedicated printers 150 located at disparate and convenient geographic locations that can be easily accessed by registered users. Dedicated printers 150 may be any standard office-style printers known in the art, such as those made by Cannon or Hewlett-Packard, capable of spooling various print jobs received from the system server 140. Though referred to herein as dedicated printers, dedicated printers 150 may have other tasks not related to the selective printing system 100 in some embodiments, in which case they may only be used on occasion to receive print jobs from the system.

In certain embodiments, dedicated printers 150 are hardwired to a dedicated computer 155, which is then networked to the system server 140. As will be further discussed, a dedicated computer 155 may be used by a registered user physically present at a dedicate printer 150 to access merged documents created by the system server from electronic documents previously submitted from a user computer 130. In this configuration, the registered user may control when and where the merged document is printed, and will be physically present to receive the merged document immediately instead of having to retrieve it from an assortment of other previously printed documents. In addition, the registered user could preview the merged document to see if any further edits are required. In such cases, the electronic merge of the advertising content and the pre-existing document content may take place at the dedicated computer 155 rather than at a network server connecting the printer with the user's computer 130.

For the system server 140, a selective printing system administrator computer 145 (or just “administrator computer”) is connected to and placed in communication with the system server 140 for interfacing with the system server 140 to provide installation, set-up, and/or ongoing maintenance interface functions.

FIG. 2 is a block diagram of a computer-based or implemented system 200 for facilitating selective printing system transactions which can be implemented within the computer-based or implemented selective printing system 100 of FIG. 1. Specifically, each registered user computer 130 of FIG. 1 can enable registered users to interface with a selective printing system application 210 through a registered user application interface 220. Similarly, advertiser computer 120 of FIG. 1 can enable the advertiser to interface with the selective printing system application 210 through advertiser application interface 230. Further, the selective printing system application 210 of FIG. 2 can also represent and generate various sets of interface screens and provide functionality for performing all of the functions provided by the selective printing system 100, and is further connected to and in communication with a selective printing system database 216 residing within a memory.

Certain embodiments may provide different application interfaces 220 depending on the type of user computer 130 that is being used. For example, in certain embodiments, the content provided through system 200 may be tailored for display on handheld devices with smaller screen sizes. Certain components of the system application 210 may even be downloaded to a mobile device 130 to facilitate its participation with the system. In this manner, participant advertisers or registered users may access and interact with the system 100 while on the move, or while physically co-located with the desired dedicated printer 150. In embodiments utilizing a dedicated computer 155, the dedicated computer would also present user application interface 220, preferably in a manner familiar to the user from previously having used the interface on user computer 130.

In still other embodiments, the system application 210 may operate through a social media network, such as FACEBOOK® (FACEBOOK® is a registered trademark of Facebook, Inc.). In this manner, system users could interact with or learn more about advertisers even as they utilize the system 100. Here, the system server 140 would still manage the advertising area, but participant advertisers would interact through the medium of the social network. The application 210 may also provide a user interface through which users can interface with or learn more about advertisers responsible for advertisements that have appeared in a document that they have printed, as is further discussed below.

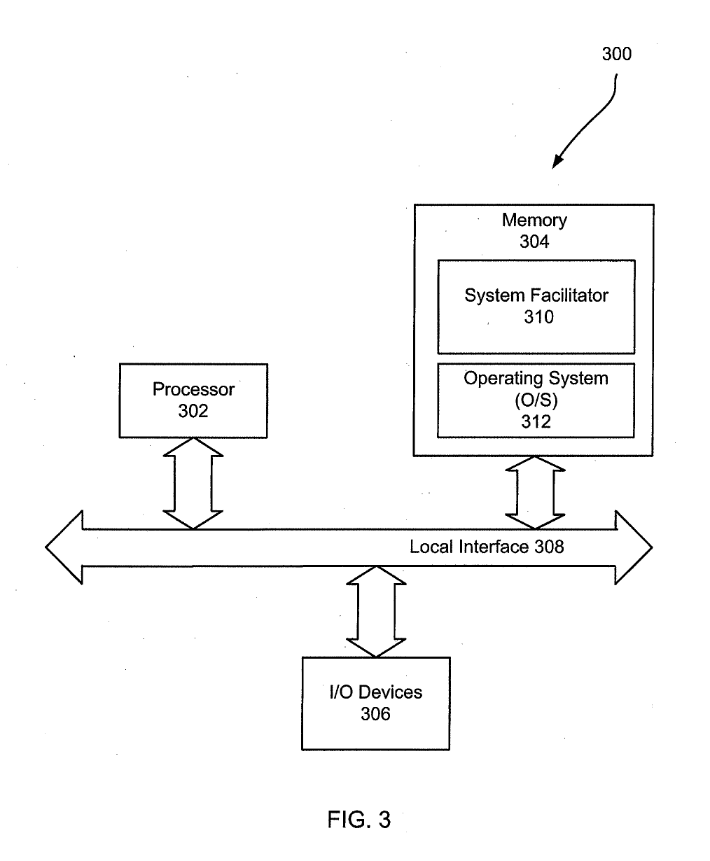

FIG. 3 is a block diagram of a computer 300 housing one or more software applications which are a part of and facilitate the selective printing system 100. Computer 300 may be any one of the system server 140, administrator computer 145, advertiser computer 120, registered user computer 130, and/or dedicated computer 155 from FIG. 1. However, in the exemplary embodiment, no individual software application is needed for advertiser computer 120 or registered user computer 130 to interact with system 100. Accordingly, for these devices, system facilitator 310 would simply take the form of a client computer-based device utilizing an Internet browsing interface application. Computer 300 may include a memory element 304. Memory element 304 may include a computer readable medium for implementing the selective printing system 100, and for implementing particular selective printing transactions.

The system facilitator 310 may be implemented in software, firmware, hardware, or any combination thereof. For example, in one mode, the system facilitator 310 is implemented in software, as an executable program, and is executed by one or more special or general purpose digital computer(s), such as a personal computer (PC; IBM-compatible, Apple-compatible, or otherwise), personal digital assistant, workstation, minicomputer, mainframe computer, computer network, “virtual network” or “internet cloud computing facility”. Therefore, computer 300 may be representative of any computer in which the system facilitator 310 resides or partially resides, such as the selective printing system server 110 of FIG. 1.

Generally, in terms of hardware architecture, as shown in FIG. 3, computer 300 includes a processor 302, memory 304, and one or more input and/or output (I/O) devices 306 (or peripherals) that are communicatively coupled via a local interface 308. Local interface 308 may be, for example, but is not limited to, one or more buses or other wired or wireless connections, as is known in the art. Local interface 308 may have additional elements, which are omitted for simplicity, such as controllers, buffers (caches), drivers, repeaters, and receivers, to enable communications. Further, local interface 308 may include address, control, and/or data connections to enable appropriate communications among the other computer components.

Processor 302 is a hardware device for executing software, particularly software stored in memory 304. Processor 302 can be any custom made or commercially available processor, a central processing unit (CPU), an auxiliary processor among several processors associated with computer 300, a semiconductor based microprocessor (in the form of a microchip or chip set), another type of microprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc., or a 68xxx series microprocessor from Motorola Corporation. Processor 302 may also represent a distributed processing architecture such as, but not limited to, SQL, Smalltalk, APL, KLisp, Snobol, Developer 200, MUMPS/Magic.

Memory 304 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory 304 may incorporate electronic, magnetic, optical, and/or other types of storage media. Memory 304 can have a distributed architecture where various components are situated remote from one another, but are still accessed by processor 302.

The software in memory 304 may include one or more separate programs. The separate programs comprise ordered listings of executable instructions for implementing logical functions. In the example of FIG. 3, the software in memory 304 includes the system facilitator 310 in accordance with the present invention, and a suitable operating system (O/S) 312. A non-exhaustive list of examples of suitable commercially available operating systems 312 is as follows: (a) a Windows operating system available from Microsoft Corporation; (b) a Macintosh operating system available from Apple Computer, Inc.; (c) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from Intel, Inc.; or (f) an appliance-based operating system, such as that implemented in handheld computers or personal digital assistants (e.g., iOS available from Apple Computer, and Windows Mobile available from Microsoft Corporation, and Android available from Google). Operating system 312 essentially controls the execution of other computer programs, such as the system facilitator 310, and provides scheduling, input-output control, file and data management, memory management, and communication control and related services.

The system facilitator 310 may be a source program, executable program (object code), script, or any other entity comprising a set of instructions to be performed. When a “source” program, the program needs to be translated via a compiler, assembler, interpreter, or the like, which may or may not be included within memory 304, so as to operate properly in connection with operating system 312. Furthermore, the advertisement system facilitator 310 can be written as (a) an object oriented programming language, which has classes of data and methods, (b) a procedural programming language, which has routines, subroutines, and/or functions, or (c) an expression oriented programming language, which has no distinction between expressions and statements. Examples of these types of programming languages include, but are not limited to, C, C++, C#, Java, JSP, PHP, Ruby on Rails, and Python.

I/O devices 306 may include input devices, for example but not limited to, input modules for PLCs, a keyboard, mouse, scanner, microphone, touch screens, interfaces for various medical devices, bar code readers, stylus, laser readers, radio-frequency device readers, etc. Furthermore, I/O devices 306 may also include output devices, for example but not limited to, output modules for PLCs, a printer, bar code printers, displays, etc. Finally, I/O devices 306 may further comprise devices that communicate with both inputs and outputs, including, but not limited to, a modulator/demodulator (modem; for accessing another device, system, or network), a radio frequency (RF) or other transceiver, a telephonic interface, a bridge, and a router.

If computer 300 is a PC, workstation, PDA, or the like, the software in memory 304 may further include a basic input output system (BIOS) (not shown in FIG. 3). The BIOS is a set of essential software routines that initialize and test hardware at startup, start O/S 312, and support the transfer of data among the hardware devices. The BIOS is stored in ROM so that the BIOS can be executed when computer 300 is activated.

When computer 300 is in operation, processor 302 is configured to execute software stored within memory 304, to communicate data to and from memory 304, and to generally control operations of computer 300 pursuant to the software. The system facilitator 310, and O/S 312, in whole or in part, but typically the latter, may be read by processor 302, buffered within processor 302, and then executed.

When the system facilitator 310 is implemented in software, as is shown in FIG. 3, it should be noted that the system facilitator 310 can be stored on any computer readable medium for use by or in connection with any computer related system or method, although in certain embodiment, the system facilitator 310 is implemented in a centralized application service provider (ASP) arrangement. In the context of this document, a computer readable medium is an electronic, magnetic, optical, or other physical device or means that can contain or store a computer program for use by or in connection with a computer related system or method. The system facilitator 310 can be embodied in any type of computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” may be any means that can store, communicate, propagate, or transport the program for use by or in connection with the instruction execution system, apparatus, or device. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

In another embodiment, where the system facilitator 310 is implemented in hardware, the system facilitator 310 may also be implemented with any of the following technologies, or a combination thereof, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

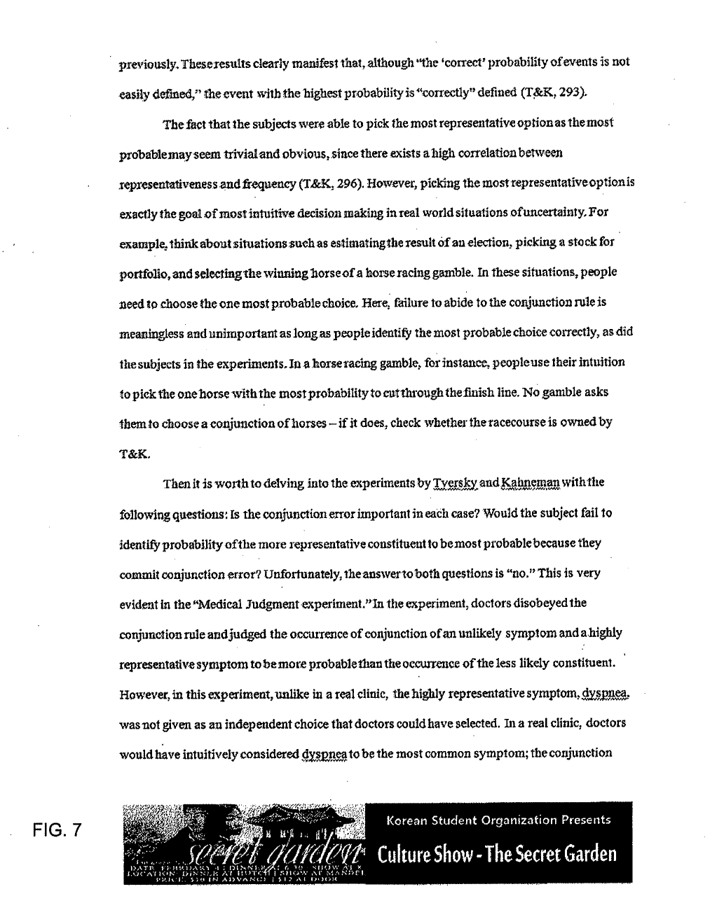

The selective printing system 100 allows for the creation of merged documents such as the excerpt of one shown in FIG. 7. A merged document is simply an electronic document that a registered user desires to have printed, combined with an advertisement submitted from an advertiser interested in reaching the registered user through a unique medium that is difficult to ignore. The original electronic document can be generally anything the registered user desires to have printed: an academic paper, a letter to a friend, a homework assignment, a draft of a business proposal or legal agreement, or an internet website. In fact, the electronic document need not be written text. It could also contain a chart, a graphic image, a diagram or any combination thereof. Generally, most documents to be printed will have margins spaced along the edges of at least an inch, providing space that can be used by the selective printing system 100 to form a merged document by adding in one or more selected advertisements. As explained below, the electronic documents can be formatted to provide sufficient margins where they do not already exist. In some embodiments, space can also be created through the formatting process to create space within electronic documents that is not associated with a margin, such as by shifting text, inserting carriage returns or page breaks prior to conducting the scan.

A registered user could be anyone desiring to frequently print documents. Though the underlying business model may vary between applications and embodiments, in the exemplary embodiment the user will receive printouts for free up to a set number in a given time period. The printing service is provided by the system operator, and funded by revenue from the advertisers that pay for the targeted placement of their advertisements. In some cases, the printer manufacturers, distributors, or servicing companies may also provide revenue through sponsorship in return for certain name recognition within the user and advertiser application interfaces and/or physically at the location of one or more of the dedicated printers 150.

This concept could be applied to a variety of groups of people or communities. For example, the dedicated printers 150 could be co-located with overnight delivery service drop off locations, coffee shops, copy shops or retail stores. Users could then have a variety of options for selecting pickup locations, and registration could be open to anyone. However, for the purposes of disclosing the exemplary embodiment, the selective printing system herein is described in the context of placement at a university or academic institution, where the registered users are students most likely printing materials related to their assignments and coursework. In such a scenario, the dedicated printers 150 would be located in places similar to where existing pay-for-copy machines are located across college campuses today.

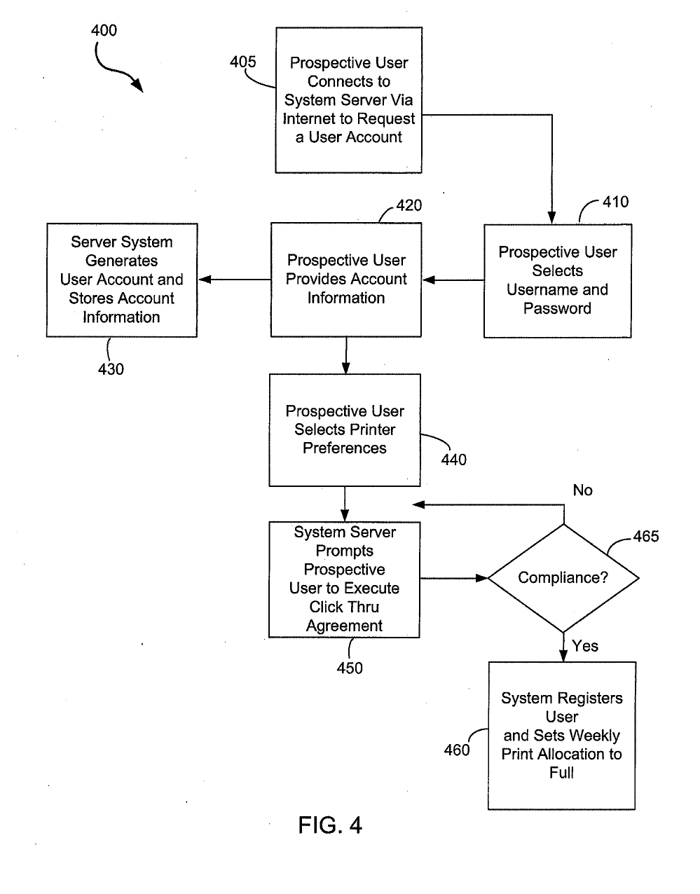

Though certain embodiments of the present invention can be performed without recognizing the user, user recognition by the system is used to help select the advertisements to be merged in the exemplary embodiment. FIG. 4 shows the process of a prospective user of selective printing system 100 becoming a registered user known to the system. In the illustrated embodiment, the printing system 100 is presented through an internet website interface. Thus, a prospective user connects to the system server 140 at step 405 using any variety of user computers 130. The server 140 prompts the user for identification, such as a username and password. Not having yet set up an account, the prospective user will not have a username and password, so will select to set up an account. At step 410, the prospective user selects a username and password to be used in association with the system 100, and possibly other security steps are taken depending on the embodiment, such as, for instance, submitting a secret answer to a question.

Through an information exchange, the system 100 requests and the user supplies certain account information to be stored by the system at step 430. Though this account information may be used for other purposes, its primary use in association with the exemplary embodiment is to match advertising with specific registered users. Thus, the type of information most useful for gathering would be demographic or occupational characteristics that might be used to create a profile for the user in an attempt to determine what products or services they may be most interested in. Such data might include, for example, age, sex, occupation, income, marital status, personal interests, employer, university, year in school, or academic major. In fact, the user's actual name and contact information many not be as important to the system 100 as this background information, and may not be requested in some embodiments to dissuade concerns over privacy. As will be seen, advertisement instructions do not identify a target audience by name, but rather by background information or demographics. To further lessen potential concerns over privacy, some material requested by the server (some fields) may not be mandatory. If not filled in, the server 140 will not consider the field when distributing advertisements.

In addition to providing account information, a user registering for the selective printing system 100 is prompted for and selects printer preferences at step 440. These preferences might include, for example, default interests such as color, resolution, paper quality or other features in some embodiments. Such selections may add cost to the user, though the ideal cost per printed page with base selections (black and white, 8.5″×11″, regular white paper, etc.) is minimal or zero to the user. As will be seen, in some embodiments the system allows remote initiation of the printing job without use of a dedicated computer 155. In such cases, it will be necessary to determine a print location from among a variety of locations having dedicated printers. Thus, a user may be prompted during registration to select a default printer location. A drop down box or other type of selection method may be used where all of the dedicated printers 150 within a specified distance from the registered user's zip code are offered. Though the user's selection is stored by the system, it may be overridden by the system 100 in the illustrated embodiment, as will be seen.

As shown in the illustrated embodiment, step 450 in registering as a user is to agree to a click-thru agreement offered by the system server 140. This agreement could contain any variety of content as desired by the system operator, but would primarily be focused on limiting the operator's liability. For example, it might ask a user to warrant that the user has the right to print the documents that the user submits to the system 100, and/or make clear that the system 100 does not assume any risk related thereto. Another request might be for the user to agree that the operator has the right to discontinue the user's account at any time, or at least for failure to follow certain enumerated guidelines. Those guidelines would be made known to the user during the registration process, and might involve things such as explaining the numerical limit on printing through the system or explaining certain system limitations as to font, imagery, print density, etc. It may also request the user to agree not to use the system 100 to print any material of a scandalous nature, and material for public display (such as politically motivated material), or other content guidelines. The click-thru agreement will allow the operator to more easily discontinue a user account if such policies are found to be violated. This may help dissuade concerns of advertisers over the content of the documents on which their advertisements will be displayed.

If the system server 140 detects an accepted click-thru agreement at step 465, the system 100 registers the user and sets the user's print allocation to full. As shown in step 460, this is a weekly allocation in the exemplary embodiment. This control is in place to prevent a single user from abusing the system. One of the goals of the system is to distribute advertisements broadly across a targeted audience. Though ideally the pool of advertisements to be placed is large, there will not be an infinite amount of advertisements that properly match with a given registered user's account information. Thus, once the matched advertisements within the pool have been merged, as will be explained below, the matched advertisements will either have to start recycling for that user or not printing at all. The selective printing system 100 operates most efficiently when each page printed is matched with one or more unique advertisements. Advertisers will see diminishing value in hitting the same registered user with the same advertisement over and over again. Accordingly, the system includes methods to limit the number of pages that a registered user may print over a given time period. Once the time period is extinguished, it will be presumed that the advertisement pool will have changed and the registered user's page count will be reset to full.

Thus, for example, the limit might be 50 or 100 pages a week. Once used up within that time period, the registered user would receive an error message and possibly the date and time when his or her page count will be reset. The actual page limit and time frame for replenishing it is controlled by the operator, but should ideally be large enough to make the system effective and useful for the registered user while not causing the system to lose its efficiency.

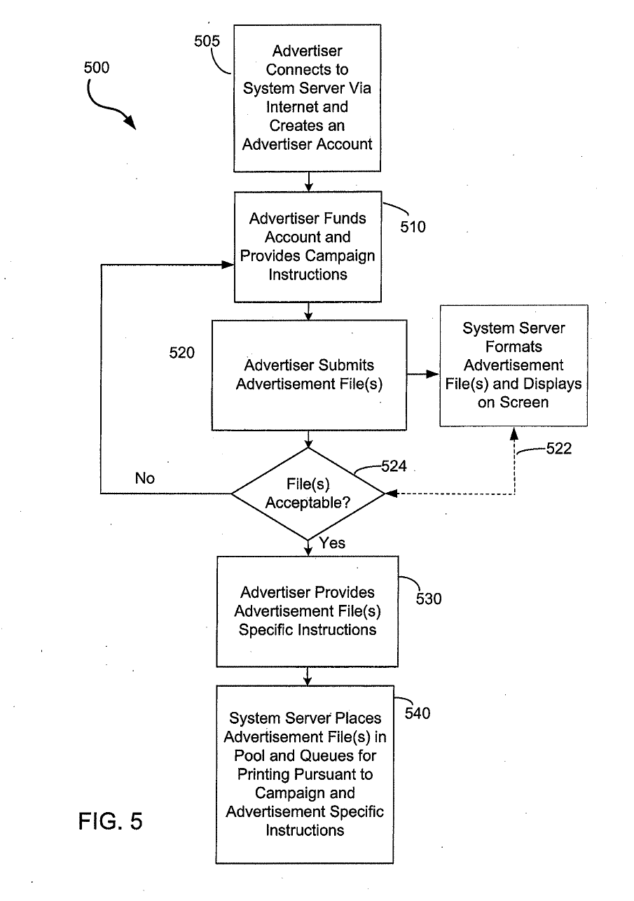

Like users, advertisers must set up an account with the system 100 in the exemplary embodiment. This process includes steps such as verifying payment account information and contact information through the selective printing system application 210, as is commonly done in the art for other secure interface applications. FIG. 5 consolidates the advertiser account set-up process into step 505 and proceeds to show the steps involved with submitting advertisements for distribution by the system. Aside from step 505, these steps would be the same regardless of whether the advertiser was a first time or repeat user. In either case, because the process occurs through the system application 210, it begins with accessing system server 140 through the Internet.

As shown in FIG. 5, the information acquired by the system from an advertiser is divided into campaign instructions and advertisement specific instructions in the illustrated embodiment. It will be understood that these labels are instructional only, and that the information acquired from the advertiser could be described or defined in a different way or in a different sequence without departing from the scope of the invention. For purposes of explaining the illustrated embodiment, campaign instructions are higher level directions about an advertising campaign or even about a particular advertiser always wants its advertisements handled, whereas advertisement instructions are specific to a particular advertisement within that campaign. Obviously where a campaign includes only one advertisement (or an advertiser submits only one advertisement to the system 100), there is less need for this distinction.

Campaign instructions are business-focused and define how many placements the advertiser wants, and over how long of a time period. They may also include placement specifics that apply to all advertisements within the campaign. In the illustrated embodiment, the advertiser provides a fixed amount advanced payment that will be expended as placements are made, at a fixed cost per placement. Thus, the campaign instruction may simply be the submission of a single advertisement and one hundred dollars for one thousand placements at $0.10 per minute. After the thousand placements have been fulfilled, the associated advertisement is removed from the eligible advertisement pool. In other embodiments, or as an alternative, an advertiser might select a set length of time, such as three weeks, over which to run the campaign. At the end of the fixed time period, any remaining pre-payment is carried forward and held within the advertiser's system account. If the money in the advertiser's system account is expended due to placements before the end of the fixed time period, the advertiser may set it up such that the system automatically drafts additional funding from a designated financial account of the advertiser. Alternatively, it may simply suspend placements and send notification to the advertiser. In some cases, the system 100 may allow advertisers that are repeat customers to operate on credit if their system account runs out before a campaign is to expire.

Campaign instructions may also identify particular days or times of the day that the corresponding advertisement(s) should be used by the system server 140. For example, if a particular advertiser operates a special on Tuesday evenings that it wishes to promote, it may request that an advertisement for that special only run on Tuesdays. If an advertiser, such as a donut shop, seeks a customer base that is active in the early morning, its campaign instructions may specify running its advertisements between the hours of 5 A.M. and 9 A.M. on any given day. Essentially, the system server 140 can be configured to limit or expand placement of the corresponding advertisements based on any placement guidelines set forth in the campaign instructions, and it would be understood to those skilled in the art that logic could be added to accommodate additional types of guidelines.

Contrary to campaign instructions which control the business transaction between the advertiser and the system and may control the global use of all advertisements submitted from the advertiser, advertisement instructions are focused on the marketing element of how a particular advertisement is to be distributed to target customers. For example, advertisement instructions will specify target demographics or background information for the registered users. Advertisement instructions might state that the advertisement is only to be presented to males between the ages of eighteen and twenty-five, to people describing themselves as engineers, or to people that identify an address within a certain radius of a certain place. Thus, as will be seen, the system application 210 matches advertisements with the account information provided by the registered users based on these instructions.

Advertisement instructions also include how the advertisement is to be placed. For instance, must it be on the bottom margin as a stand-alone advertisement on the page? Can it be merged to a document consecutively with other advertisements? Are there any specific advertisers or advertisements with which it should not share a page? What is the maximum number that the advertisement may be displayed to any one registered user within the target audience? Each feature selected by the advertiser for the advertisement that leans toward exclusivity, prominent display or requiring extra determination steps by the system would tend to increase the placement cost. For example, an Office Depot® advertisement requesting page exclusivity, limiting itself to a single print per target user, and refusing placement within a document that also includes an advertisement for Staples® will cost much more than an advertisement with only advertisements related to the target audience.

In step 510, an advertiser provides a fixed amount of money into its system account to fund an advertisement campaign and provides campaign instructions, such as for how long to run and whether to draft additional funds if needed. Next, the, advertiser submits one or more advertisement files to be associated with the campaign at step 520. This submission is a simple upload process from the advertiser computer 120 to the system server 140. The system may present certain limitations/instructions on upload, such as to file size and type parameters. As shown in optional step 522, some embodiments of the system application 210 allow an advertiser to see how the advertisement image will be displayed within the margins of a given document. If this is not to the advertiser's liking, the advertiser may decide to modify the image to make it look better. In some embodiments, system application 210 would also provide functionality to facilitate such modification remotely, such as by pixelating the advertisement image and allowing it to be cropped, enlarged or shrunk.

The system application 210 should be able to recognize and properly manipulate the submitted advertisement(s). Because of the size of the margin space, the advertisement images should be relatively long in width and short in height (or vice versa depending on the margin used and the advertisement orientation). In some embodiments, if the image dimensions do not allow for legible placement in a margin even after reasonable formatting by the system, an error message will be generated and the advertiser will be asked to submit a different advertisement file. Such a message would also result if the system application 210 cannot open or manipulate the advertisement file because of it being of an unsupported file type that cannot be properly manipulated or reformatted.

While the exemplary embodiment shows the advertisement being submitted by the advertiser, it will be understood that advertisements could also be generated by or under the instruction of the system operators, for example, based on information provided by the advertiser. One advantage to such a method is that the system operators are better positioned to know what image format and size is system compatible and available for placement in the majority of electronic document types. In addition, system operators may be able to generate various sizes and shapes of a similar ad such that the proper one can be selected based on the available space within a document. The ad may also be generated in a fashion to make it more amenable to dynamic, or “on the fly” modification by the system to conform with the space available in a given electronic document.

At step 530, the advertiser submits the advertisement specific instructions used by the system application 210 to identify the target registered users, and also any specifics as to exclusivity (where on documents the advertisement should be place, whether it can be repeated to the same registered user, etc.). These instructions need not be uniform across the different advertisements within a campaign, and, thus, are shown in a separate step from receiving campaign information. Finally, at step 540, the system application 210 places the new advertisement(s) in the advertisement pool such that it is ready for placement when a document is to be printed by a registered user having the characteristics specified in the advertisement information.

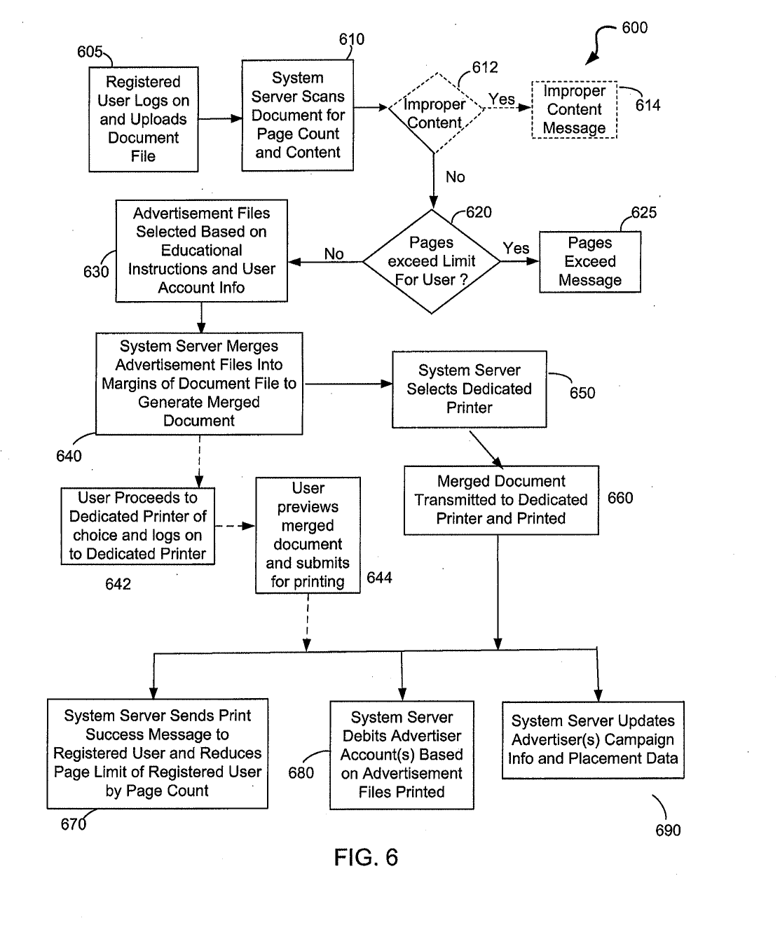

FIG. 6 shows the system activity associated with the actual placement of an advertisement. This activity presumes that a registered user has supplied the account information discussed in association with FIG. 4, and that advertisers have advertisements in the system with advertisement instructions corresponding to the registered user's account information. At step 605, the registered user logs onto the system through user computer 130 and transmits a document to be printed to the selective printing system server 140 using the user application interface 220. In the exemplary embodiment, the document will be scanned at step 610 into a universal format such as a .pdf that the system can easily manipulate. Thus, so long as the transmitted document is of a file type that the system can open and scan, it will be supported.

The scan process may serve several purposes, as shown by steps 612 and 620. Step 612 is shown as an optional step that may be used in an attempt to flag electronic documents that may not comply with system use guidelines. For example, if the system operator (or a particular advertiser) is concerned about use of the documents in public display, the scan may be looking for characters of a font size that can be seen from a distance. Such fonts would not likely be found in a regular text document. If a submitted document is flagged, the system server 140 may generate a message denying the particular print job, or requiring the user to await system operator review.

Another function of the scan is to determine the number of pages that will be printed. This is obviously important if the registered user has a fixed allotment of pages that will print for the reduced or free system price. Thus, where the document includes more pages than the registered user has remaining on his or her account within the present time period, the system server will generate a message indicating this at step 625. In some embodiments, the system may then provide the user the option of completing the print job at a higher rate for those pages that exceed his or her remaining allotment. The page count is also necessary for the system server 140 to determine how many advertisements can be interspersed throughout the document, and by how many the registered user's page count should be reduced (step 670).

Though not shown on FIG. 6, another function of the scan, if necessary, is to format the electronic document in a manner to create a useful margin space. Typical document margins are one inch on all sides. However, page numbering, headers or footers may use even this space, leaving nearly no effective room for advertisements. In such cases, the overall scanned image of any given page of the document may be proportionately reduced so as to create a useful margin space. In other cases, the system automatically reformats the electronic document to be printed so as to create space before the document scan is performed. This feature is dependent on the format of the document uploaded for printing. For example, if it is in a word processing format, the software can interact with the document to dynamically modify it. However, if the electronic document is uploaded as a PDF or GIF image, dynamic reformatting will not be available. Another possible scan function not shown is to determine if the document has color. Alternatively, selecting color may be offered as an option to the registered user at the time of document upload (step 605). Color ink is typically more expensive, so selection of this option may come at an incremental price in some embodiments.

Once the document is scanned and the margins are prepared (if necessary), the system application 210 searches database 216 to identify advertisements that have campaign and advertisement instructions corresponding to the registered user's account information. In most cases, there will be several advertisements that have instructions indicating they are a match with the particular user. Each such advertisement is referred to herein as a “candidate advertisement.” Using the example of a university setting, a test prep company might be advertising a prep course for the Medical College Admission Test (“MCAT”), and may only want to display this advertisement to students majoring in biology or life sciences. If such a student submits a document, the system application 210 would identify the MCAT prep course advertisement as a candidate advertisement. Ultimately, the selection of which candidate advertisements to place within the document will be made by the system application 210 based on a variety of factors such as: whether the candidate advertisement has been shown to the registered user before, which of the candidate advertisements has been waiting for placement the longest, or other such factors as the system operator might build in to manage the advertisement pool.

Information needed to help select from among candidate advertisements (who has seen it, when last placed, etc.) is stored in the advertiser accounts associated with the candidate advertisements located on database 216, and is updated after a placement occurs (step 690). This information may also, or alternatively, be stored in user accounts stored on the same database. In addition, the system application 210 must follow the campaign instructions associated with any particular candidate advertisement selected. For example, is it permissible to place the advertisement on a page with another advertisement from a different advertiser? Are there specific positional instructions for advertisements associated with the campaign? Is it within a time window that advertisements within the campaign are allowed to run? The campaign information will also be available on database 216.

In some embodiments, where factors such as those above are taken into consideration and there remain multiple candidate advertisements eligible, an intensity metric may be considered. This metric is generally a numeric identifier relating to the importance of the advertisement to the system. For example, an advertiser may have paid a premium price for preferential treatment of the advertisement, or the advertisement may be associated with a return client or high-volume client, etc. In this case, other factors being equal, the advertisement with the higher intensity metric will be selected.

Once the selective printing system application 210 has selected the advertisements that it will print along with the document and has determined where and how the advertisements will be placed within the document, the application generates a merged document at step 640 where the advertisements appear in the document margins. Because a universal format (such as .pdf) is used once the scan is complete, this may be done through an electronic printing step where one overlay is printed over another. The merged document is then ready to be printed.

The next question addressed by the system is where to print the document. FIG. 6 discloses different options for this, depending on whether the embodiment includes dedicated computer 155. Dedicated computer 155 is simply a workstation computer co-located with dedicated printer 150. Like with the dedicated printer 150, it will be understood that dedicated computer 155 may serve other purposes than use with the selective printing system 100. However, it is configured to drive the dedicated printer 150, and has access to at least the system server 140 through user application interface 220. Following FIG. 6 through an embodiment having dedicated computers 155, the user simply proceeds to the dedicated printer 150 of their choice at Step 642 when they are ready to retrieve the merged document. The user then uses the registered user application interface 220 to log on to the system server 140, retrieves the merged document at Step 644, and selects the commands causing it to be printed at the dedicated printer 150 connected directly to the dedicated computer 155. In this manner, the registered user can preview the merged document prior to see if any final edits need to be made prior to printing. In certain embodiments, the system enables the user to delete the merged document from the print queue (i.e., cancel printing). The system would prohibit removal of or alteration of the advertisement content, however. For example, the system server 140 could lock the advertisement component of the merged document using known PDF management tools.

It will be understood that dedicated computer 155 could also serve as user computer 130. In other words, in embodiments having dedicated computers co-located with the dedicated printers, a registered user could simply upload the document to be printed from a dedicated printer 155 where it could be merged with the selected advertisement by the system server 140 and sent back to the dedicated computer 155 for immediate printing at the dedicated printer 150.

As seen from FIG. 6, the system 100 can also function in the absence of a dedicated computer 155. In this case, the server 140 directs the merged document to a dedicated printer directly. Once the dedicated printer has received the merged document (and instructions as necessary), the print job is queued and eventually printed. Assuming the dedicated printer 150 is networked and used by many people, it may be set up to print a username on a cover page to mark the beginning of the document. There may also be local document handlers that place documents into document pickup bins in an order that will facilitate the registered user finding and retrieving the document. Thus, the dedicated printer may be remote from the registered user at the time of document upload.

Following such an embodiment, at step 650, the system application 210 selects a dedicated printer 150 and transmits the merged document to the printer for printing. In the exemplary embodiment, the application 210 will first look to registered user's account information and attempt to use his or her default dedicated printer. This selection may be overridden by either the registered user (such as by selecting an alternate dedicated printer for this particular print job via a dropdown box through application interface 220 when uploading the document (not shown on FIG. 6)) or by the system application 210 itself. In the latter case, the system application ping the dedicated printer to be sure it is responding and available to take the print job. If it is not responding, the system application will defer to the geographically closest working alternate dedicated printer.

Where the dedicated printer 150 is only used by the system 100, the print settings default will be set such that printing out to near the edge of the page in anticipated. This avoids cutting off any portion of the margin advertisements. However, an additional step may be necessary where the dedicated printer is used for other non-system print jobs in order to ensure the merged document prints properly. Though not shown in FIG. 6, this would involve the system server 140 or dedicated computer 155 altering the print settings for the particular print job such that the entire merged document will be shown when printed.

As noted above, in various embodiments, the selective printing system 100 enables a registered user to select one of the plurality of dedicated printers that the user desires to print the user's merged document. In certain such embodiments, the selective printing system 100 includes one or more features that provides additional information about the dedicated printers to enable the registered user to make a more informed decision as to which dedicated printer to select for printing the merged document.

More specifically, in various embodiments, the selective printing system 100 enables the user to view certain information about each of one or more of the dedicated printers such as, but not limited to: the location of that dedicated printer (either globally or relative to another location, such as the user's location, the user's home or office address, or the location of the user's mobile device); whether that dedicated printer is online or offline; whether that dedicated printer is in an error mode and awaiting service or is functioning properly; the quantity of documents in that dedicated printer's print queue; the estimated time before that dedicated printer will begin printing the merged document; the estimated time at which that dedicated printer will finish printing the merged document; that dedicated printer's maximum print quality; that dedicated printer's color capability (e.g., black and white or color); an estimate of that dedicated printer's remaining amount of ink or toner; and/or an estimate of that dedicated printer's remaining loaded paper. The server 140 communicates with the dedicated printers and updates and pushes this information to the user application interface 220 in real-time so that the user has the most up-to-date information when making her dedicated printer selection.

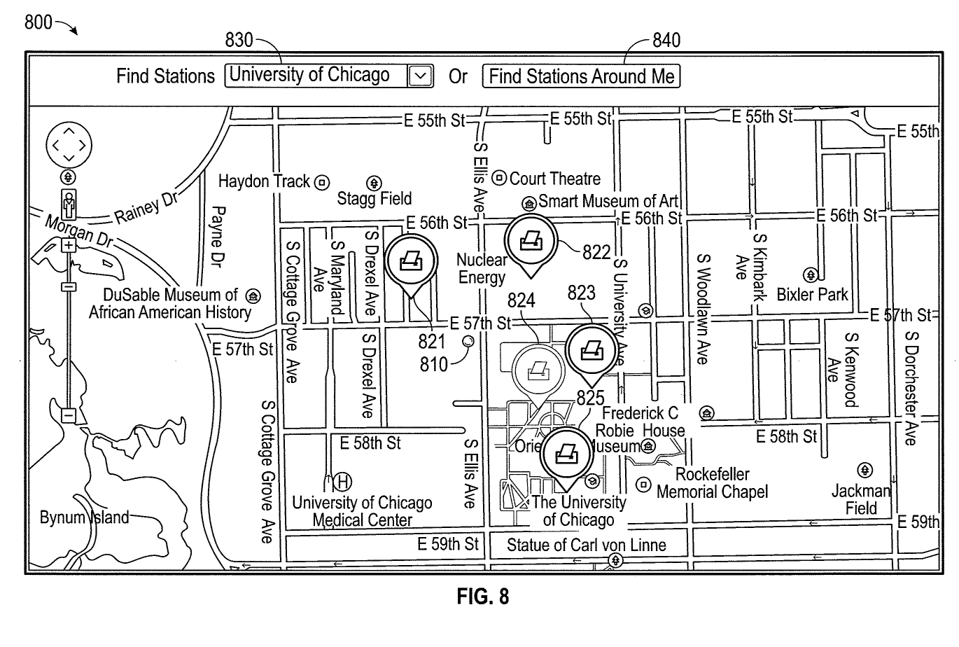

In certain embodiments, the user application interface 220 enables the user to choose to view a map that includes an indication of the user's location (or any other suitable location input by the user) and an indication(s) of the location(s) of any dedicated printers within a designated proximity of the user's location. This enables the user to quickly and easily choose to print the merged document at a dedicated printer that is close to the user and easily accessible. For instance, in one example embodiment, the map indicates the user's location and the location(s) of any dedicated printers within a designated distance of the user's location. FIG. 8 illustrates an example screenshot 800 of the user application interface including a map including an indication 810 of the user's location and a plurality of indications 821, 822, 823, 824, and 825 of the locations of a plurality of dedicated printers within a designated distance of the user's location. In this example embodiment, the user application interface includes: (1) a first button 830 that, if actuated, causes the system to find and display indications of the locations of any dedicated printers within a designated area (e.g., a particular city) or near a designated location (e.g., a university, a museum, a shopping mall, and the like); and (2) a second button 840 that, if actuated, causes the system to find and display indications of the locations of any dedicated printers within a designated distance of the user's location.

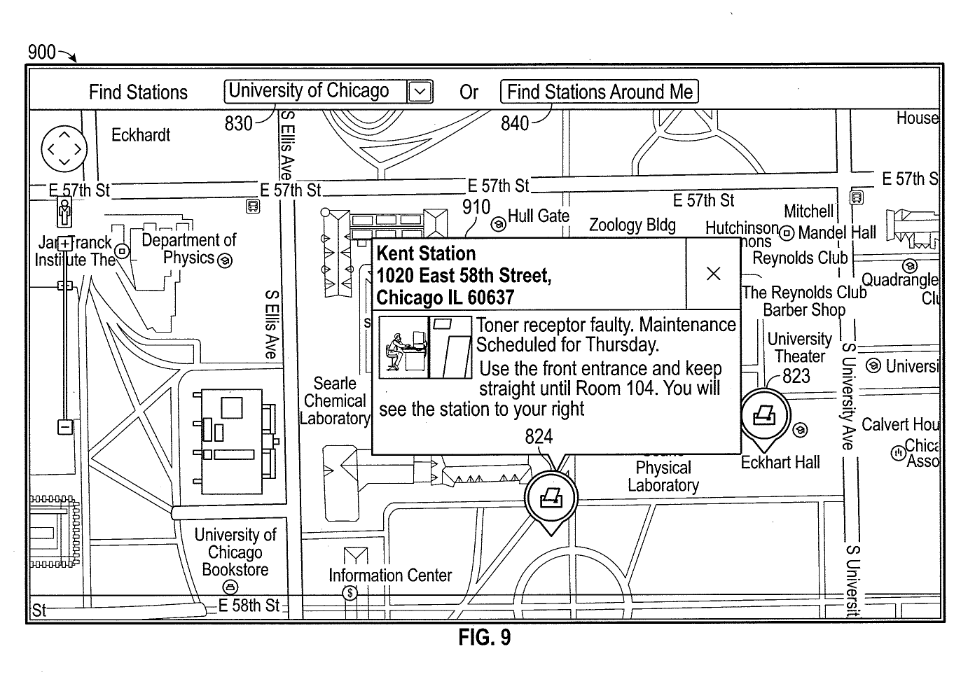

In one such embodiment, the user application interface 220 enables the registered user to select any of the displayed indications of the dedicated printers and, if the user does so, the user application interface 220 displays additional information about that dedicated printer (such as any of the above-listed information). FIG. 9 illustrates an example screenshot 900 of the user application interface of FIG. 8 after the system has received a selection of the indication 824. In this illustrated example, after receiving the selection of the indication 824, the system causes a display of a pop-up window 910 that includes: (1) the address at which the associated dedicated printer is located, (2) the status of the dedicated printer, and (3) directions to the dedicated printer, though it should be appreciated that any suitable information may be included in the pop-up window

In certain such embodiments, the user application interface 220 color-codes (or otherwise differentiates) the displayed indications of the dedicated printers to indicate certain information about the dedicated printers. For instance, in one example embodiment, the user application interface 220 displays: a green indicator for any dedicated printers that are online, functioning properly, and estimate finishing printing the user's merged document within ten minutes from the time of submission; a yellow indicator for any dedicated printers that are online, functioning properly, and estimate finishing printing the user's merged document more than ten minutes from the time of submission; and a red indicator for any dedicated printers that are either offline or in an error mode and awaiting service.

In other such embodiments, the user application interface 220 displays a projected time of print job completion in association with each displayed indication of each dedicated printer. The projected time of print job completion reflects the time at which the selective printing system 100 predicts that that particular dedicated printer would complete the user's print job (i.e., complete printing the user's document, if submitted). The selective printing system 100 may take any suitable factors into account when determining the projected time of print job completion such as, but not limited to, the quantity of documents currently in that dedicated printer's print queue, the page length of the user's document, whether the user's document is to be printed in black and white or color, the amount of loaded paper remaining in that dedicated printer, and/or the remaining amount of ink or toner in that dedicated printer.

In other embodiments, the selective printing system 100 determines a recommended dedicated printer based on certain of the above-listed information about the dedicated printers and one or more filters provided by the registered user or the system itself. For instance, in one example embodiment, the selective printing system 100 recommends the designated printer that is online and closest to the user's location. In another example embodiment, the selective printing system 100 recommends the designated printer that is online and that is the shortest commute from the user's location. In a further example embodiment, the selective printing system 100 recommends the online designated printer within one mile of the user's location for which the estimated time at which that dedicated printer will finish printing the merged document is the earliest.

Returning to FIG. 6, once the merged document is printed, the system application 210 performs several steps to document this occurrence. First, at step 670, it reduces the registered user's page limit as appropriate based on the number of pages printed. In embodiments not using a dedicated computer 155, or where the registered user opted to have the merged document send directly to the dedicated printer from a remote user computer 130, the system server 140 will generate a message to the registered user that the document has been printed and is ready for pickup at an identified location. At step 680, the system application 210 causes the proper advertisers' accounts to be debited for the advertisement placement(s) that occurred from the printing of the merged document. This may be debiting an actual dollar amount held in retainer, or it might simply be reducing the number of pre-paid placements remaining for the effected advertisement campaign.

Finally, the system server 140 updates the affected advertiser(s) account to reflect the placement(s) made. The placement information may be used by the system application 210 to generate a campaign status report available for viewing by the advertiser(s) through advertiser application interface 230 at any time. This may be preferred by the advertiser(s) over receiving a message each time one of the advertiser(s) advertisements are placed. The update to the advertiser account also identifies that a particular advertisement has now been shown to a particular user. Depending on the embodiment, the system may or may not reveal the actual user's identity to the advertiser. However, the advertiser account within database 216 will identify that a particular user has been shown an advertisement “x” amount of times. In this manner, once “x” exceeds a certain amount, the advertisement in question will no longer be considered a candidate advertisement for print jobs from that particular user.

In some embodiments, system server 140 also updates the affected user's account by doing more than just reducing the user's print count. Specifically, electronic information about the advertisers responsible for advertisements placed in the user's electronic document can be stored by system server 140 in the user's account. This information can be later accessed by the user to take advantage of certain offers, or to interact with the advertisers. For example, say a user prints a document at a dedicated printer 155, and then reads the document while traveling to their next destination. It being Valentine's Day, within the document is an advertisement for flowers from a nearby florist. This reminds the user to send flowers to his wife. But instead of calling the phone number in the advertisement, or typing information into a web browser, the user simply opens a component of system application 210 stored on his mobile device and logs into his user account. There, he finds the advertisements that have been shown to him, and identifies the one from the flower shop. With the click of a button, the user can then be directed to the website of the flower shop to set up an order.

Also, the information on the user's account could include special offers from the flower shop that are specific to users of selective printing system 100. For example, the flower shop might include an electronic coupon that can be submitted with an order to receive a discount on the price. This provides further motivation to interact with the advertisers through the system. According to one embodiment, an electronic coupon might comprise a QR code or other scannable indicia that could be accessed through a user's account via a user's mobile device, read by the device, and submitted at the point of sale (whether electronic or otherwise) to receive an automatic discount off the purchase of goods or services from the advertiser.

Another benefit of electronic coupons is that it further enables the selective printing system 100 to provide feedback to advertisers regarding the effectiveness of their advertising campaign. Instead of just reporting advertising placement, the system could automatically indicate a user's actions relating to the placement, such as, for example, accessing electronic information about the placed advertisement that has been stored in the user account, using the information to access a website, or redeeming an electronic coupon provided through the system. Furthermore, the fact that a user takes advantage of an electronic coupon, or accesses information about an advertiser stored in their user account is, itself, useful information about the user that can be appended to the user's profile. For example, an advertisement instruction associated with a particular advertisement file might specify that use is preferred with those user's that have previously taken active steps to interact with an advertiser or redeemed a coupon after a placement on a print job was made. A point system or reward system could also be put in place to encourage user interaction with the electronic information that is placed in their account as a result of a paper advertisement placement in one or more of their electronic documents.

In various embodiments, when a registered user transmits a document to be printed to the selective printing system 100, the system 100 enables the user to instruct the system 100 to print the user's document (or a portion of the user's document) advertisement-free if one or more prerequisites are met or one or more conditions are satisfied. Put differently, in these embodiments, if the user meets the one or more prerequisites or satisfies the one or more conditions, the selective printing system 100 enables the user to choose to cause the system 100 to print the user's document without merging the user's document with any advertisements.

In certain such embodiments, the selective printing system 100 enables a registered user to accumulate points (or any other suitable “currency”) by completing designated tasks offered by the system 100 and to later redeem those accumulated points for advertisement-free printing. Thus, in these embodiments, when the user transmits a document to be printed to the selective printing system 100, the system 100 enables the user to instruct the system 100 to print the user's document (or a portion of the user's document) advertisement-free when the user meets the prerequisite of having accumulated enough points to qualify for such advertisement-free printing.

More specifically, in these point-accumulation embodiments, the selective printing system 100 stores (such as in the database 216, described above) or is otherwise configured to access (such as via communication with one or more third-party servers or storage devices) a plurality of different designated tasks. These designated tasks may be any suitable tasks such as, but not limited to: viewing a video; completing and submitting a survey; providing a verified email address for inclusion in an email distribution list; visiting a particular website; downloading a mobile application; downloading software; creating a user account on a website; ordering a product or a service; “liking” or “friending” a particular entity on FACEBOOK®; and/or “following” a particular entity on TWITTER® (TWITTER® is a registered trademark of Twitter, Inc.).

In various embodiments, each task may be a system task that the operator of the system 100 submits or an advertiser task that an advertiser submits (or that is otherwise associated with the advertiser). Certain system tasks, once completed by a user, provide the selective printing system 100 with information that the system 100 can later use to match (or better match) that particular user with an advertisement. For instance, one example system task is a survey that asks a user to identify the user's favorite foods. Once the user completes this task, the system updates the user's account information to include the user's favorite foods such that the system 100 can use that information to identify advertisements that have campaign and advertisement instructions corresponding to the registered user's account information. The introduction of tasks thus provides a more robust system (that is more adept at pairing users with relevant advertisements) while also providing users an additional benefit (i.e., advertisement-free printing).

Certain advertiser tasks, such as viewing a video provided by the advertiser, visiting the advertiser's website, and downloading the advertisement's mobile application, are themselves advertisements and do not provide any (substantial) information to the advertiser about the user who completes those advertiser tasks. In certain embodiments, the selective printing system 100 counts completion of these tasks toward views of that advertiser's advertisements (i.e., the advertiser task is completed in lieu of merging a document with the advertiser's advertisement). Other advertiser tasks, such as completing a survey, provide the advertiser with additional information about the user that the advertiser can then user to create more effective advertisements or tasks, to create more effective campaign instructions, to create more effective advertisement instructions, and the like. Thus, in these embodiments, the system 100 transmits the results of users' completion of advertiser tasks to the advertiser(s) for their internal use.

In various embodiments, each of the plurality of designated tasks is associated with a quantity of points. The quantity of points associated with a particular designated task may be set in any suitable manner. In one embodiment, more time-consuming and/or difficult designated tasks are associated with relatively higher quantities of points than less time-consuming and/or difficult designated tasks. For instance, in one example embodiment, a survey including five questions is associated with two points while a survey including twenty-five questions is associated with ten points.

The selective printing system 100 may enable a registered user to undertake and complete one or more designated tasks in a variety of different manners. In various embodiments, for each registered user of the selective printing system 100, the system 100 stores (such as in the database 216) or is otherwise configured to access (such as via communication with one or more third-party servers or storage devices) a list of available designated tasks for that particular user. In certain embodiments, for each user, the selective printing system 100 (at least initially) includes all of the plurality of designated tasks in the list of available designated tasks for that particular user. In other embodiments, for each user, the selective printing system 100 (at least initially) includes a plurality of, but fewer than all of, the plurality of designated tasks in the list of available designated tasks for that particular user. In one such embodiment, for each user, the selective printing system 100 determines which tasks of the plurality of designated tasks to include in the list of available designated tasks for that particular user based at least in part on the user's account information. For instance, in one example embodiment, each task is associated with task rules, and the system 100 matches a particular user with a particular task by comparing the user's user information with the task rules of the various tasks in a manner similar to that described above with respect to FIG. 6. This ensures that the tasks available for a particular user are tailored to and of interest to that particular user.

In certain embodiments, the selective printing system 100 enables a registered user to undertake and complete one or more of the designated tasks in the user's list of available designated tasks on-demand. That is, in these embodiments, the selective printing system 100 presents the user (such as by causing the user application interface 220 to display) with the user's list of available designated tasks and enables the user to choose one of the designated tasks on the list that the user desires to undertake.

In other embodiments, at certain instances, the selective printing system 100 actively offers a designated task to a registered user and enables the user to choose to accept that designated task (and then undertake and complete that designated task) or to reject that designated task. The selective printing system 100 may do so at any suitable instance, such as, but not limited to, hourly, daily, weekly, monthly, whenever a new designated task is added to the user's list of available designated tasks, whenever a new designated task satisfying certain user-set requirements is added to the user's list of available designated tasks, and/or whenever the system determines that a new designated task should be matched with the user based on a comparison of the user's user information and the task rules of that new designated task. For instance, in one example embodiment, the selective printing system 100 actively pushes a notification to a mobile device of the user (i.e., causes the user application interface 220 to display the notification) every Sunday that offers the user 10 points if the user agrees to watch (and then watches) a video.

Generally, when a registered user undertakes and completes one of the designated tasks in the user's list of available designated tasks, the selective printing system 100 increases a point balance of the user by the quantity of points associated with that particular completed designated task. The selective printing system 100 may store the point balances of its registered users in any suitable manner, such as via the database 216.

In certain embodiments, the selective printing system 100 may limit how often a registered user can undertake certain designated tasks. For instance, in one example embodiment, the selective printing system 100 limits the user to undertaking one designated task per hour, day, week, or month. In other embodiments, the selective printing system 100 limits how many points a registered user can accumulate during a particular time period. For instance, in one example embodiment, the selective printing system 100 limits the user to accumulating no more than twenty-five points per week. In further embodiments, the selective printing system 100 places an upper limit on a registered user's point balance such that the user's point balance does not exceed a designated maximum point balance. For instance, in one example embodiment, the selective printing system 100 limits the user's point balance to a maximum of 100 points.

In one embodiment, the selective printing system 100 does not enable a registered user to undertake and complete the same designated task more than once. For instance, in one example embodiment in which the selective printing system 100 stores a list of available designated tasks for a registered user, once the user completes one of those available designated tasks and the system 100 provides the user with the quantity of points associated with that completed designated task, the system 100 removes that completed designated task from the user's list of available designated tasks such that the user cannot undertake that same designated task again. In one embodiment, the selective printing system 100 adds that (once-completed) designated task back into the user's list of available designated tasks once a designated period has expired. Continuing with the above example embodiment, the selective printing system 100 adds that (once-completed) designated task back into the user's list of available designated tasks (and again provides the user with the quantity of points if the user undertakes and completes that designated task) after a period of six months has expired since the user previously completed that designated task.

In another embodiment, the selective printing system 100 enables a registered user to undertake and complete the same designated task more than once, but does not provide the user with any additional points for undertaking and completing the same designated task more than once. For instance, in one example embodiment in which the selective printing system 100 stores a list of available designated tasks for a registered user, once the user undertakes and completes one of those available designated tasks and the system 100 provides the user with the quantity of points associated with that completed designated task, the system 100 does not remove that completed designated task from the user's list of available designated tasks, but does not provide the user with any additional points the next time the user undertakes and completes that particular designated task.

In another embodiment, the selective printing system 100 enables a registered user to undertake and complete the same designated task more than once, but provides the user with fewer points each subsequent time the user completes that designated task. For instance, in one example embodiment in which the selective printing system 100 stores a list of available designated tasks for a registered user, when the user completes an available designated task a first time, the system 100 provides the user with ten points, i.e., the full quantity of points associated with that completed designated task. In this example embodiment, the second time the user completes that same available designated task, the system 100 provides the user with six points; the third time the user completes that same available designated task, the system 100 provides the user with three points; the fourth time the user completes that same available designated task, the system 100 provides the user with one point; and the fifth time the user completes that same available designated task, the system 100 does not provide the user with any points. In another embodiment, the system 100 removes that available designated task from the user's list of available designated tasks once the user cannot accumulate any points by undertaking and completing that designated task.

In certain embodiments, after a registered user has accumulated enough points such that the user's point balance at least equals a page print cost, when the user transmits a document to be printed to the selective printing system 100, the system 100 enables the user to redeem a quantity of the user's accumulated points for one or more advertisement-free printed pages. In these embodiments, the selective printing system 100 sets the page print cost to any suitable quantity of points (such as one point). In these embodiments, the selective printing system 100 enables the user to choose which particular pages of the document the user desires to be printed advertisement-free, and requires the user to redeem a quantity of points equal to the page print cost multiplied by the total quantity of selected pages to cause the system 100 to print those pages advertisement-free. For instance, in one example embodiment in which the page print cost is one point and in which a registered user has accumulated fifty points, when the user transmits a thirty-one page document to be printed to the selective printing system 100, the system 100 enables the user to redeem up to thirty-one of the user's points for up to thirty-one advertisement-free printed pages. So, in this example embodiment, if the user desires that the system 100 print twenty-four pages of the thirty-one page document advertisement-free, the user redeems twenty-four points in exchange for those twenty-four pages of advertisement-free printing. The system 100 prints the remaining seven pages with advertisements (as described above).

In certain embodiments, when a registered user transmits a document to be printed to the selective printing system 100, the system 100 determines a document print cost (as translated to user “points”) and, if the user has accumulated enough points such that the user's point balance at least equals the document print cost, enables the user to redeem a quantity of the user's accumulated points for an advertisement-free printed document. In these embodiments, the selective printing system 100 determines the document print cost in any suitable manner. In one embodiment, the system 100 determines the document print cost based on the quantity of pages in the document (e.g., the more pages, the higher the document print cost). In another such embodiment, the system 100 determines the document print cost based on the file size of the document (e.g., the larger the file size, the higher the document print cost). In another such embodiment, the system 100 determines the document print cost based on the estimated amount of ink or toner used to print that document (e.g., the more ink or toner used, the higher the point cost).

For instance, in one example embodiment, when a registered user transmits a thirty-one page document to be printed to the selective printing system 100, the system 100 determines a document print cost of twenty points. Since the user's point balance exceeds twenty points, the system 100 enables the user to redeem twenty of the user's points for an advertisement-free printed document.

In other embodiments, rather than enabling registered users to accumulate points and to later redeem those accumulated points for advertisement-free printing, when the user transmits a document to be printed to the selective printing system 100, the system 100 determines whether to offer advertisement-free printing and, if so, enables the user to undertake and complete one or more designated tasks in exchange for advertisement-free printing. Thus, in these embodiments, when the user transmits a document to be printed to the selective printing system 100, the system 100 prints the user's document (or certain portions of the user's document) advertisement-free when the user meets the prerequisite of having undertaken and completed one or more designated tasks.

In these embodiments, when a registered user transmits a document to be printed to the selective printing system 100, the system 100 determines whether to offer advertisement-free printing of that document in any suitable manner. In one embodiment, the system 100 determines whether to offer advertisement-free printing of a document based on the quantity of pages in the document (e.g., advertisement-free printing is not available for documents exceeding a certain quantity of pages). In another such embodiment, the system 100 determines whether to offer advertisement-free printing of a document based on the file size of the document (e.g., advertisement-free printing is not available for documents exceeding a certain file size). In another such embodiment, the system 100 determines whether to offer advertisement-free printing of a document based on the estimated amount of ink or toner used to print that document (e.g., advertisement-free printing is not available for documents exceeding a certain estimated ink or toner usage). In certain embodiments, the system 100 determines whether to offer advertisement-free printing of a document based on how often the user has received advertisement-free printing (e.g., a particular user can only receive one advertisement-free printed document within a designated period, such as one week). In other embodiments, the system 100 determines whether to offer advertisement-free printing of a document based on whether at least one system task is available for the user to undertake. In various embodiments, the system 100 determines whether to offer advertisement-free printing based on whether at least one advertiser task is available for the user to undertake. In other embodiments, the selective printing system offers advertisement-free printing for all documents.

In various embodiments, when the selective printing system 100 determines to offer advertisement-free printing of a document, the system 100 determines one or more designated tasks that the registered user must undertake and complete before the system 100 prints the document advertisement-free. The designated tasks may be any suitable tasks, such as those described above. In one embodiment, the system 100 determines which particular designated task(s) to require the user to undertake and complete based on the quantity of pages in the document (e.g., the more pages, the more designated tasks the system 100 requires the user to undertake and complete and/or the more time-consuming designated task(s) the system 100 requires the user to undertake and complete). In another such embodiment, the system 100 determines which particular designated task(s) to require the user to undertake and complete based on the file size of the document (e.g., the larger the file size, the more designated tasks the system 100 requires the user to undertake and complete and/or the more time-consuming designated task(s) the system 100 requires the user to undertake and complete). In another such embodiment, the system 100 determines which particular designated task(s) to require the user to undertake and complete based on the estimated amount of ink or toner used to print that document (e.g., the more ink or toner used, the more designated tasks the system 100 requires the user to undertake and complete and/or the more time-consuming designated task(s) the system 100 requires the user to undertake and complete).

In one example embodiment including both system tasks and advertiser tasks, after a user submits a document to be printed to the selective printing system 100, the system 100 determines whether the system 100 desires additional information associated with the user to include in the user's user information. If the system 100 desires additional information, the system 100 offers the user advertisement-free printing of the document in exchange for the user undertaking and completing one or more system tasks. If the user accepts the system task offer, the system 100 enables the user to complete the system task(s) and, once completed, prints the document advertisement free (such as described above with respect to blocks 642, 644, 650, and 660 of FIG. 6).

In this example embodiment, if, on the other hand, the user declines the system task offer, the system 100 pairs the user with one or more advertisers in a manner similar to that described above with respect to FIG. 6. Once the system 100 pairs the user with an advertiser(s), the system 100 determines whether that advertiser(s) has any available advertiser tasks that the system 100 can offer the user in exchange for advertisement-free printing of the document. If not, the system 100 proceeds to block 630 of FIG. 6. If so, the system 100 offers the user advertisement-free printing of the document in exchange for the user undertaking and completing one or more advertiser tasks. If the user accepts the advertiser task offer, the system 100 enables the user to complete the advertiser task(s) and, once completed, prints the document advertisement free (such as described above with respect to blocks 642, 644, 650, and 660 of FIG. 6). If, on the other hand, the user rejects the advertiser task offer, the system 100 proceeds to block 630 of FIG. 6.

In another example embodiment, the selective printing system 100 enables users to accumulate points (which the user can exchange for advertisement-free printing) by completing system tasks but does not enable users to accumulate points by completing advertiser tasks. Instead, in this embodiment, the system 100 provides advertisement-free printing when the user completes an advertiser task or tasks. For instance, in one such embodiment, if the user submits a document to be printed to the system 100 and the user's point balance is too low to obtain advertisement-free printing of that document, the system 100 enables the user to complete one or more advertiser tasks (if available) and prints the document advertisement-free once the user completes the advertiser task(s).

As noted above, in certain embodiments, the selective printing system 100 uses any results of certain of the completed designated tasks to update the account information of the registered user who completed that designated task. This enables the system 100 to better match advertising with that specific registered user in the future, as described above in association with step 430 of FIG. 4. In various embodiments in which the designated tasks are supplied by a third party, the selective printing system 100 may send any results of the designated tasks (e.g., survey results) to that third party.

Accordingly, it should now be clear how selective printing system 100 can be used by registered users and advertisers in a symbiotic manner to provide a useful service while opening up an untapped medium for selective and targeted distribution of advertisements. Any process descriptions or blocks in the figures, such as FIGS. 4-6, should be understood as representing modules, segments, or portions of code which include one or more executable instructions for implementing specific logical functions or steps in the process, and alternate implementations are included within the scope of the embodiments of the present invention in which functions may be executed out of order from that shown or discussed, including substantially concurrently or in reverse order, depending on the functionality involved, as would be understood by those having ordinary skill in the art.

It should be emphasized that the above-described exemplary embodiments of the present invention, and particularly any “preferred” embodiments, are possible examples of implementations, merely set forth for a clear understanding of the principles of the invention. Many other variations and modifications may be made to the above-described embodiments of the invention without substantially departing from the spirit and principles of the invention. All such modifications are intended to be included herein within the scope of this disclosure and the present invention and protected by the following claims.

What is claimed is:

1. A computer-implemented system for managing print advertisement campaigns, said computer-implemented system comprising:
a database configured to store user account information in a plurality of user accounts and advertiser account information in a plurality of advertiser accounts, wherein each user account contains profile data identifying characteristics of a user, and wherein each advertiser account contains at least one advertisement file corresponding to an advertisement;
a processor in electronic communication with the database; and
a printer in electronic communication with the processor,
wherein the processor is programmed to operate with the database and the printer to:
(a) receive an electronic document from a first user, the electronic document including one or more pages;
(b) if a designated condition is met, cause the printer to print the electronic document such that the electronic document does not include any advertisements; and
(c) if the designated condition is not met:
(1) identify a plurality of candidate advertisement files from among the advertisement files stored on the database by comparing the advertisement instructions associated with the advertisement files stored on the database with the profile data stored in a user account associated with the first user;
(2) determine at least one selected advertisement file from among the plurality of candidate advertisement files;
(3) merge an advertisement image associated with the at least one selected advertisement file into the electronic document; and
(4) cause the printer to print the electronic document including the merged advertisement image.

2. The computer-implemented system of claim 1, wherein the processor is further programmed to:
(i) receive a request from the first user to perform a first one of a plurality of designated tasks;
(ii) enable the first user to perform the first designated task; and
(iii) after the first user has completed the first designated task, update a point balance of the first user using a quantity of points associated with the completed first designated task,
wherein the designated condition is met when the point balance of the first user at least equals a designated point threshold and a request for advertisement-free printing is received.

3. The computer-implemented system of claim 2, wherein the processor is further programmed to, if the designated condition is met, reduce the point balance of the first user.

4. The computer-implemented system of claim 3, wherein the point balance reduction is based at least in part on a quantity of the one or more pages of the electronic document printed without any advertisements.

5. The computer-implemented system of claim 3, wherein the processor is further programmed to, if the designated condition is met, receive, from the first user, an indication of which of the one or more pages of the electronic document to print without any advertisements.

6. The computer-implemented system of claim 2, wherein the processor is further programmed to, after updating the point balance of the first user using the quantity of points associated with the completed first designated task, not enable the first user to perform the first designated task for a designated period.

7. The computer-implemented system of claim 2, wherein the processor is further programmed to update the profile data in the user account associated with the first user based on the completed first designated task.

8. The computer-implemented system of claim 1, wherein the processor is further programmed to:
(i) if it is determined to offer the first user advertisement-free printing, offer the first user advertisement-free printing in exchange for the first user completing a designated task; and
(ii) if an acceptance of the offer is received, enable the first user to perform the first designated task,
wherein the designated condition is met when the first user completes the designated task.

9. The computer-implemented system of claim 1, further including a plurality of printers, wherein the processor is programmed to operate with the database and the printers to cause a display of a map, said map including, for each of the plurality of printers within a designated proximity of a location of the first user, an indication of said printer at a location of said printer relative to the location of the first user.

10. The computer-implemented system of claim 9, wherein each displayed indication of a printer is selectable and selection of a displayed indication of a printer by the first user causes the display of information associated with said printer.

11. The computer-implemented system of claim 9, wherein the processor is programmed to interface with each of the plurality of printers to determine the location of said printer relative to the location of the first user at the time of receipt of the electronic document from the first user.

12. The computer-implemented system of claim 11, wherein the indication is a function of an aspect of the electronic document selected from the group consisting of: a quantity of pages, color content, and estimated ink or toner usage.

13. The computer-implemented system of claim 12, wherein, for each printer, the displayed indication of said printer includes an estimated time at which said printer could finish printing the electronic document.

14. The computer-implemented system of claim 9, wherein, for each printer, the displayed indication of said printer includes at least one condition of said printer selected from the group consisting of: offline, busy, and available.

15. The computer-implemented system of claim 9, wherein the processor is programmed to interface with each of the plurality of printers at a designated time interval and dynamically update the map including the displayed indications of the plurality of printers at each time interval.

16. A computer-implemented method for managing print advertisement campaigns, said computer-implemented method comprising:
(a) receiving, via a processor, an electronic document from a first user, the electronic document including one or more pages;
(b) if a designated condition is met, printing, via a printer, the electronic document such that the electronic document does not include any advertisements; and
(c) if the designated condition is not met:
(1) identifying, via the processor, a plurality of candidate advertisement files from among a plurality of advertisement files stored on a database by comparing advertisement instructions associated with the advertisement files stored on the database with profile data stored in a user account associated with the first user;
(2) determining, via the processor, at least one selected advertisement file from among the plurality of candidate advertisement files;
(3) merging, via the processor, an advertisement image associated with the at least one selected advertisement file into the electronic document; and
(4) printing, via the printer, the electronic document including the merged advertisement image.

17. The computer-implemented method of claim 16, further including:
(i) receiving, via the processor, a request from the first user to perform a first one of a plurality of designated tasks;
(ii) enabling the first user to perform the first designated task; and
(iii) after the first user has completed the first designated task, updating, via the processor, a point balance of the first user using a quantity of points associated with the completed first designated task,
wherein the designated condition is met when the point balance of the first user at least equals a designated point threshold and a request for advertisement-free printing is received.

18. The computer-implemented method of claim 16, which includes causing, via the processor, a display of a map, said map including, for each of a plurality of printers within a designated proximity of a location of the first user, an indication of said printer at a location of said printer relative to the location of the first user.

19. The computer-implemented method of claim 16, which includes interfacing, via the processor, with each of the plurality of printers at a designated time interval and dynamically updating the map including the displayed indications of the plurality of printers at each time interval.

20. A computer-implemented system for managing print advertisement campaigns, said computer-implemented system comprising:
a database configured to store user account information in a plurality of user accounts and advertiser account information in a plurality of advertiser accounts, wherein each user account contains profile data identifying characteristics of a user and at least one advertiser account contains at least one advertisement file with associated advertisement instructions;
a processor in electronic communication with the database; and
a printer in electronic communication with the processor,
wherein the processor is programmed to operate with the database and the printer to:
(a) receive an electronic document from a first user, the electronic document including a quantity of one or more pages; and
(b) if the quantity of pages of the electronic document does not exceed a remaining quantity of pages included in the profile data of the first user:
(i) identify a plurality of candidate advertisement files from among the advertisement files stored on the database by comparing the advertisement instructions associated with the advertisement files stored on the database with the profile data stored in a user account associated with the first user;
(ii) determine a selected advertisement file from among the plurality of candidate advertisement files;
(iii) if an advertisement image associated with the selected advertisement file cannot fit into the electronic document without occluding any text of the electronic document, reformat one of (1) the electronic document and (2) the advertisement image such that the advertisement image will fit into the electronic document without occluding any text of the electronic document;
(iv) merge the advertisement image into the electronic document;
(v) cause the printer to print the electronic document including the merged advertisement image; and
(vi) update the profile data in the user account associated with the first user to reflect placement of the at least one selected advertisement file.

21. The computer-implemented system of claim 20, wherein the reformatting of the advertisement image includes changing a size of the advertisement image.

22. The computer-implemented system of claim 20, wherein the processor is further programmed to remove from the plurality of candidate advertisement files any files containing advertisement instructions specifying use only on a date or during a time period that does not correspond to a date or time period at which the processor receives the electronic document.

23. The computer-implemented system of claim 20, wherein the processor is further configured to remove from the plurality of candidate advertisement files any files containing an advertisement image that the profile data of the first user identifies as having been previously presented to the first user more than a pre-determined number of times within a designated period.

24. The computer-implemented system of claim 20, wherein the processor is further programmed to determine the selected advertisement file from among the plurality of candidate advertisement files based on at least one selected from the group consisting of: a length of time since the advertisement image associated with the at least one selected advertisement file was last selected for placement by the processor, a number of times the advertisement image associated with the at least one selected advertisement file has been selected for placement by the processor, and an amount of time until a pre-determined expiration date defined within the at least one selected advertisement file.

25. The computer-implemented system of claim 20, wherein the processor is further programmed to provide to the first user with account access to an electronic coupon associated with goods or services displayed in the advertisement image associated with the selected advertisement file, and
wherein the electronic coupon includes a scannable indicia for use in association with a purchase of a good or service identified by the selected advertisement image.
